(19) United States
(12) Patent Application Publication
(10) Pub. No.: US 2005/0107102 A1
(43) Pub. Date: May 19, 2005

(54) Method of relaying connection requests between wireless devices in wireless network and apparatus therefor

(75) Inventors: Jung-min Yoon, Seoul (KR); Hyung-chan Kim, Suwon-si (KR); Sang-cheol Moon, Seoul (KR); Yoon-moon Shin, Seongnam-si (KR); Tao-soo Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/991,868

(22) Filed: Nov. 19, 2004

(30) Foreign Application Priority Data
Nov. 19, 2003 (KR) 2003-82334

(51) Int. Cl. H04Q 7/20

(52) U.S. Cl. 455/466

(57) ABSTRACT

An apparatus to relay connection requests between wireless devices in a wireless network including at least one piconet having a master device and one or more slave devices, the apparatus including a connection request relay unit in the master device to relay to a first wireless device a request from a second wireless device to connect to the first wireless device, wherein the first wireless device is one of the oner or more slave devices, and the second wireless device is outside the at least one piconet having the master device, and a method of relaying the connection requests.

### CROSS-REFERENCE TO RELATED APPLICATIONS

This application claims the priority of Korean Patent Application No. 2003-82334, filed on Nov. 19, 2003, in the Korean Intellectual Property Office, the disclosure of which is incorporated herein in its entirety by reference.

### BACKGROUND OF THE INVENTION

1. Field of the Invention

The present invention relates to an ad hoc wireless network, and, more particularly, to a method of relaying connection requests between blue tooth devices to support an ad hoc wireless network, and an apparatus therefor.

2. Description of the Related Art

An ad hoc wireless network is a dynamic network. The ad hoc wireless network is formed when a plurality of nodes are determined to connect to each other to form a network. Since each of the nodes in the ad hoc wireless network operates as a host or a router, the ad hoc wireless network does not need an infrastructure required in a fixed network. That is, the ad hoc wireless network is a communication network formed through wireless modems according to users' needs without using repeaters, such as a public communication network and a satellite network. Therefore, a protocol of the ad hoc wireless network assumes that physical locations of the nodes are not always the same.

BLUETOOTH® is a standard for composing an ad hoc wireless network using wireless local area communication. BLUETOOTH® devices are nodes of the ad hoc wireless network. The BLUETOOTH® standard supports both piconet and scatternet networks in order to support the ad hoc wireless network.

With reference to FIG. 1A, the piconet is a network for a plurality of slave devices S1-S7 to be connected to a master device M. Since the piconet uses a maximum of 8 nodes, the maximum number of slave devices is 7. In the piconet, each slave device can directly communicate with the master device.

With reference to FIG. 1B, the scatternet is formed by a plurality of independent and asynchronous piconets. To form the scatternet, at least one device (or node) included in more than one piconet is necessary. The device (or node) included in more than one piconet is a forwarding node or a gateway node. Nodes 101 and 102 of FIG. 1B are devices included in more than one piconet.

Since each of all BLUETOOTH® devices can search and connect to other BLUETOOTH® devices in order to support the ad hoc wireless network, the BLUETOOTH® standard supports both piconet and scatternet networks.

However, the present BLUETOOTH® chips cannot fully support the scatternet due to difficulty of realization. Therefore, since BLUETOOTH® devices connected as slaves to one BLUETOOTH® device cannot reply to connection requests or inquiry messages of other BLUETOOTH® devices, the reach of the ad hoc wireless network is limited.

The limitation is also applied to an access point. Therefore, if the access point is connected to a device by a connection request of the device, a role switching is performed between the access point and the device. Accordingly, since the access point is set to a master status and the device issuing the connection request is set to a slave status, the access point can receive connection requests from other devices.

With reference to FIG. 2, if a service provision device 201 is connected to an access point 202, the access point 202 is set as a master device of a piconet 200 and the service provision device 201 is set as a slave device of the access point 202. At this time, if a service client device 203, which is not connected to the piconet 200, transmits a connection request or an inquiry message to the service provision device 201, the service provision device 201 cannot reply to the connection request or the inquiry message. That is, connection between the service provision device 201 and the service client device 203 cannot be performed.

Therefore, since the service client device 203 has to wait until the service provision device 201 is disconnected with the access point 202 or until service provision device 201 issues a connection request to the service client device 203, it may take a long time for the service client device 203 to get a service.

Furthermore, since many and unspecified devices can issue connection requests to the service provision device 201, the service provision device 201 cannot know when and to what device the service provision device 201 has to issue a connection request. Therefore, the service client device 203, which wants a service from the service provision device 201, has to continuously poll the service provision device 201.

### SUMMARY OF THE INVENTION

The present invention provides a method of relaying a connection request to minimize connection waiting time between BLUETOOTH® devices supporting an ad hoc wireless network, and an apparatus therefor.

The present invention also provides a method of relaying, and an apparatus to relay, a connection request of a service client device, which wants a service to be supplied, in response to a service provision device being a slave device in an ad hoc wireless network based on BLUETOOTH® wireless communication.

Additional aspects and/or advantages of the invention will be set forth in part in the description which follows and, in part, will be obvious from the description, or may be learned by practice of the invention.

According to an aspect of the present invention, there is provided a method of relaying connection requests between wireless devices in a wireless network including at least one piconet having a master device and one or more slave devices, the method including: determining whether a second wireless device exists in the one or more slave devices connected to a master device in response to the master device receiving a connection relay request for the second wireless device from a first wireless device; and relaying the connection request to the second wireless device so that the second wireless device attempts to connect to the first wireless device in response to the second wireless device existing.

According to another aspect of the present invention, there is provided a method of relaying connection requests between wireless devices in a wireless network which communicates through an access point operating as a master device, the method including: determining whether a second wireless device exists in one or more slave devices connected to the access point in response to the access point receiving a connection relay request for the second wireless device from a first wireless device, wherein the determining is done by the access point; and relaying the connection request to the second wireless device by the access point in response to the second wireless device existing, so that the second wireless device, as a master device of the first wireless device, attempts to connect to the first wireless device.

According to another aspect of the present invention, there is provided an apparatus to relay connection requests between wireless devices in a wireless network including at least one piconet having a master device and at least one slave device, the apparatus including: a connected device list module included in the master device to manage, in a connected device list, a list of devices connected to the master device; a connection request relay module included in the master device to search the connected device list module in response to a connection relay request for a second wireless device being received from a first wireless device, and to order a relay of a connection request in response to the second wireless device existing in the connected device list; and a connection manager included in the master device to relay the connection request to the second wireless device so that the second wireless device attempts to connect to the first wireless device in response to a relay order of the connection request being received from the connection request relay module.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a network diagram of a piconet;

FIG. 1B illustrates a network diagram of a scatternet;

FIG. 2 illustrates a connection diagram between wireless devices in a conventional wireless network;

FIG. 3 illustrates a connection diagram between wireless devices when a connection request between the wireless devices in an ad hoc wireless network is relayed, according to an embodiment of the present invention;

FIG. 4 illustrates a function block diagram of the relay agent of FIG. 3; and

FIG. 5 is a flowchart of a method of relaying a connection request between wireless devices in a wireless network according to an embodiment of the present invention.

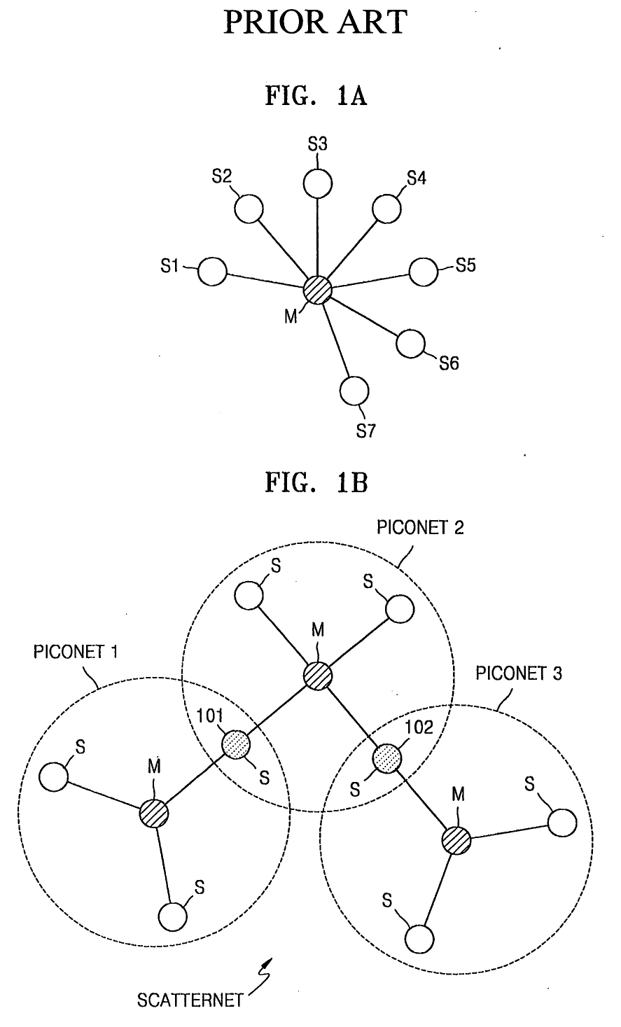

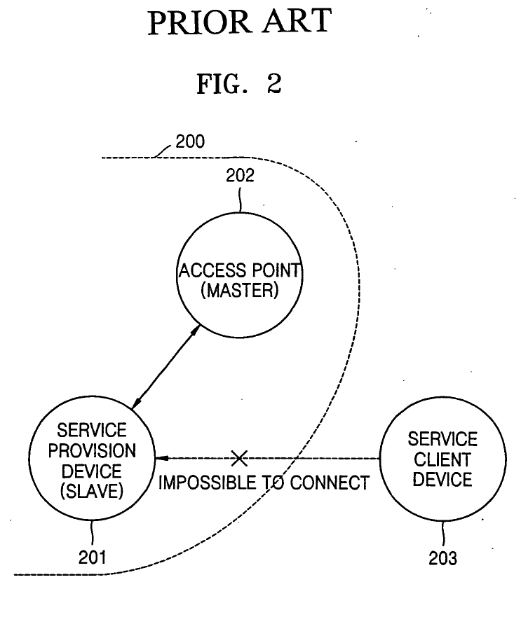

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

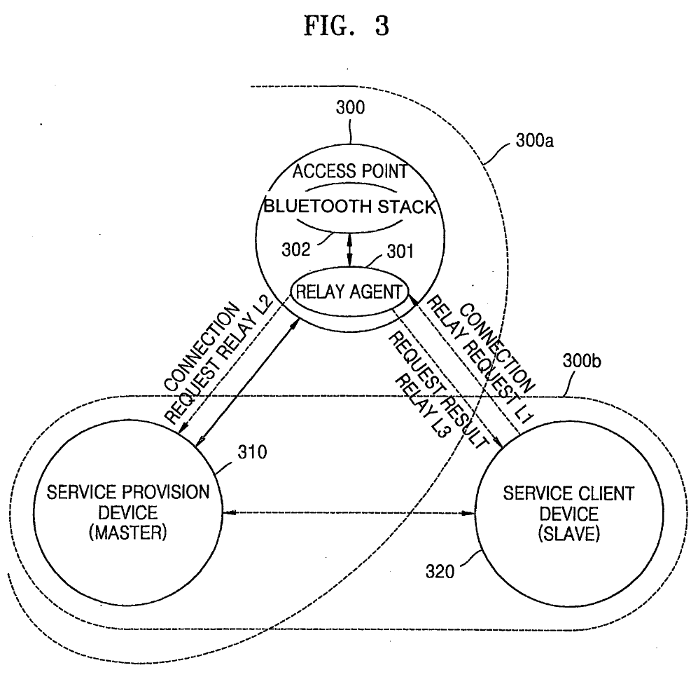

FIG. 3 illustrates a connection diagram between wireless devices when a connection request between the wireless devices in an ad hoc wireless network is relayed, according to an embodiment of the present invention. That is, FIG. 3 is a connection diagram between wireless devices illustrating a situation in which a service provision device 310 is connected to a piconet 300a in which an access point 300 is a master device, and a service client device 320, which is not connected to the piconet 300a, requests a relay of connection to the service provision device 310. The service client device 320 may be a master device of another piconet.

The access point 300, the service provision device 310, and the service client device 320 are BLUETOOTH® capable devices.

The access point 300 is a master device of the piconet 300a, and includes a relay agent 301, which relays a connection relay request of the service client device 320, and a BLUETOOTH® stack 302.

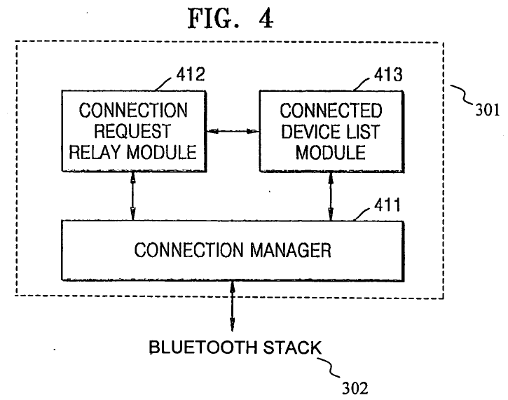

The relay agent 301 is an apparatus to relay connection requests between wireless devices according to this embodiment of the present invention. With reference to FIG. 4, the relay agent 301 includes a connection manager 411, a connection request relay module 412, and a connected device list module 413.

When a new connection or a disconnection occurs at the access point 300, the connection manager 411 informs the connected device list module 413 of the change, and updates a connected device list. Also, the connection manager 411 is a channel between the BLUETOOTH® stack 302 and the connection request relay module 412. That is, the connection manager 411 informs the connection request relay module 412 of an event output from the BLUETOOTH® stack 302, and transfers the result to the BLUETOOTH® stack 302.

In the present invention, the event is a connection request relay L1 transmitted from the service client device 320 in FIG. 3. Also, the result is a connection request relay L2 transmitted to the service provision device 310, and a request result relay L3 transmitted to the service client device 320, in FIG. 3.

When the connection manager 411 receives a relay order of a connection request from the connection request relay module 412, the connection manager 411 transmits the connection request relay L2 through the BLUETOOTH® stack 302 so that the service provision device 310, as a master device of the service client device 320, tries to connect to the service client device 320. At this time, the connection manager 411 transmits the address of the service client device 320 to the service provision device 310.

When the connection request relay module 412 receives the connection request relay L1, the connection request relay module 412 searches the connected device list which is managed in the connected device list module 413, and determines whether a wireless device (the service provision device 310), to which the connection request is transmitted, exists.

If the wireless device (the service supply device 310) to which the connection request is transmitted exists, the connection request relay module 412 issues the relay order of the connection request to the connection manager 411, and informs the wireless device (the service provision device 310) of the request for the connection relay. If the wireless device (the service provision device 310) to which the connection request is transmitted does not exist, the connection request relay module 412 does not issue the relay order of the connection request, and informs the result to the wireless device (the service client device 320) which has requested the connection relay.

The connected device list module 413 updates and manages the connected device list through the connection manager 411 whenever a device is newly connected or disconnected with the access point 300.

The BLUETOOTH® stack 302 can communicate with other BLUETOOTH® capable wireless devices. Therefore, even though BLUETOOTH® stacks are not shown in the service provision device 310 and the service client device 320, the service provision device 310 and the service client device 320 also include BLUETOOTH® stacks such as the BLUETOOTH® stack 302.

When the service provision device 310 receives the connection request from the access point 300, the service provision device 310 requests a connection from the service client device 320 using the address of the service client device 320. Then, when a BLUETOOTH® connection with the service client device 320 is established, the service provision device 310 supplies a service to the service client device 320. Accordingly, the piconet 300b is formed, where the service provision device 310 is a master device and the service client device 320 is a slave device.

When the service client device 320 receives the request result relay L3 from the access point 300, the service client device 320 disconnects the BLUETOOTH® connection with the access point 300, and awaits a connection request from the service provision device 310.

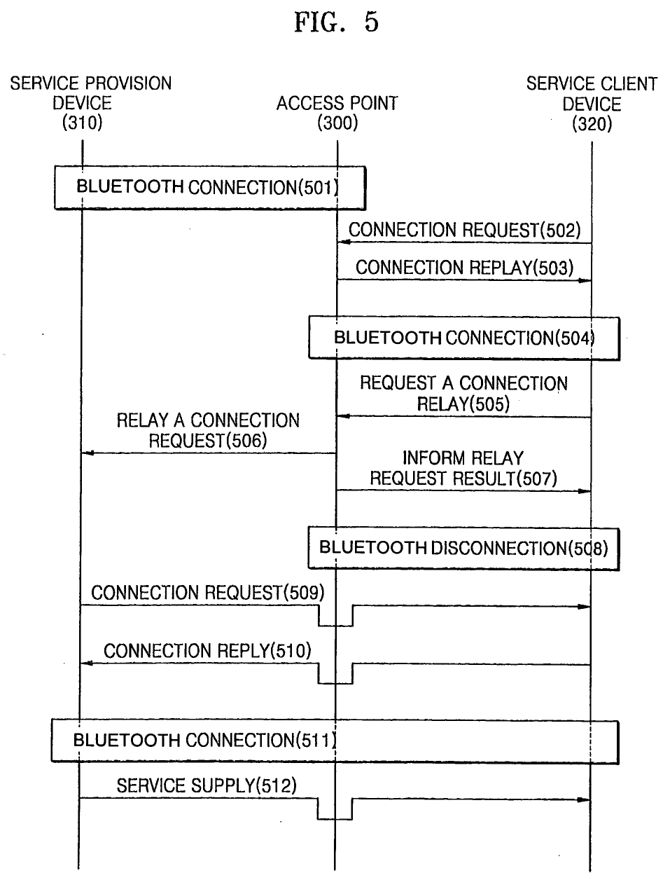

FIG. 5 is a flowchart of a method of relaying a connection request between wireless devices in a wireless network according to an embodiment of the present invention.

In the case in which a BLUETOOTH® connection is established between the access point 300 and the service provision device 310 (501), when the service client device 320 transmits a connection request to the access point 300 (502), and the access point 300 transmits a connection reply to the service client device 320 (503), a BLUETOOTH® connection between the access point 300 and the service client device 320 is formed (504). The service client device 320 may be a master device of another piconet, but not of the piconet in which the access point 300 is included.

The service client device 320 sends a request for a connection relay with the service provision device 310 to the access point 300 in operation 505.

The access point 300 determines the existence of the service provision device 310 for which the connection relay is requested, with reference to a connected device list included in the relay agent 301.

If the service provision device 310 exists in the connected device list, the relay agent 301 in the access point 300 relays the connection request to the service provision device 310 in operation 506. At this time, the relay agent 301 in the access point 300 supplies the address of the service client device 320 to the service provision device 310.

The relay agent 301 in the access point 300 informs the service client device 320 of the result of the relay request in operation 507. Thereby, the service client device 320 disconnects the BLUETOOTH® connection with the access point 300 in operation 508, and awaits a connection request from the service provision device 310.

The service provision device 310 makes a request to connect to the service client device 320 using the address of the service client device 320 in operation 509.

When the service client device 320 replies to the connection request in operation 510, a BLUETOOTH® connection between the service provision device 310 and the service client device 320 is formed in operation 511, and the service provision device 310 supplies a service to the service client device 320 in operation 512.

In the embodiment described above, the access point 300 is defined as a master device, and the service provision device 310 and the service client device 320 are defined as wireless devices supporting a wireless network.

As described above, in the present invention, since a service client device tries to connect to a service provision device by relaying a connection request from the service client device through a master device (an access point) of the service provision device when the service provision device supporting an ad hoc wireless network based on BLUETOOTH® is set to a slave status, the waiting time of the service client device according to the connection request is minimized. Thereby, the reach of the ad hoc wireless network using BLUETOOTH® devices is magnified.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of relaying connection requests between wireless devices in a wireless network including at least one piconet having a master device and one or more slave devices, the method comprising:
determining whether a second wireless device exists in the one or more slave devices connected to a master device in response to the master device receiving a connection relay request for the second wireless device from a first wireless device, wherein the determining is done by the master device; and
relaying the connection request to the second wireless device so that the second wireless device attempts to connect to the first wireless device in response to the second wireless device existing.

2. The method of claim 1, wherein the first wireless device is a wireless device in a different piconet than the piconet in which the second wireless device is included at the time the master device receives the connection relay request.

3. The method of claim 1, wherein the master device determines the existence of the second wireless device by referring to a connected device list.

4. The method of claim 1, wherein the first wireless device, the second wireless device, and the master device are BLUETOOTH® capable devices.

5. A method of relaying connection requests between wireless devices in a wireless network which communicates through an access point operating as a master device, the method comprising:
determining whether a second wireless device exists in one or more slave devices connected to the access point in response to the access point receiving a connection relay request for the second wireless device from a first wireless device, wherein the determining is done by the access point; and
relaying the connection request to the second wireless device by the access point in response to the second wireless device existing, so that the second wireless device, as a master device of the first wireless device, attempts to connect to the first wireless device.

6. An apparatus to relay connection requests between wireless devices in a wireless network including at least one piconet having a master device and at least one slave device, the apparatus comprising:
a connected device list module included in the master device to manage, in a connected device list, a list of devices connected to the master device;
a connection request relay module included in the master device to search the connected device list module in response to a connection relay request for a second wireless device being received from a first wireless device, and to order a relay of a connection request in response to the second wireless device existing in the connected device list; and
a connection manager included in the master device to relay the connection request to the second wireless device so that the second wireless device attempts to connect to the first wireless device in response to a relay order of the connection request being received from the connection request relay module.

7. The apparatus of claim 6, wherein the connection manager updates the connected device list module in response to a device being newly connected or disconnected with the master device.

8. The apparatus of claim 6, wherein the first wireless device is a wireless device in a different piconet than the piconet in which the second wireless device is included at the time the connection relay request is received.

9. The apparatus of claim 6, wherein the first wireless device, the second wireless device, and the master device are BLUETOOTH® capable devices.

10. The apparatus of claim 6, wherein the connection manager relays the connection request so that the second wireless device, as a master device of the first wireless device, attempts to connect to the first wireless device.

11. The apparatus of claim 6, wherein the connection manager relays the connection request through a BLUETOOTH® stack in the master device.

12. A method of relaying connection requests between wireless devices in a wireless network including at least one piconet having a master device and one or more slave devices, the method comprising:
receiving in the master device a request from a first wireless device to connect to a second wireless device, wherein the first wireless device is outside the at least one piconet having the master device;
determining in the master device whether the second wireless device exists in the one or more slave devices; and
relaying by the master device the request to the second wireless device in response to the second wireless device existing in the one or more slave devices.

13. The method of claim 12, further comprising attempting to connect, by the second wireless device, to the first device in response to the second wireless device receiving the request.

14. The method of claim 12, wherein the master device and the first and second wireless devices are BLUETOOTH® capable devices.

15. An apparatus to relay connection requests between wireless devices in a wireless network including at least one piconet having a master device and one or more slave devices, the apparatus comprising:
a connection request relay unit in the master device to relay to a first wireless device a request from a second wireless device to connect to the first wireless device;
wherein the first wireless device is one of the one or more slave devices, and the second wireless device is outside the at least one piconet having the master device.

16. The apparatus of claim 15, further comprising a connected device list unit in the master device to manage, in a connected device list, a list of devices connected to the master device.

17. The apparatus of claim 16, wherein connection request relay unit determines whether the first wireless device is one of the one or more slave devices by searching the connected device list.

18. The apparatus of claim 17, wherein the connection request relay unit relays the request from the second wireless device to the first wireless device in response to the first wireless device being identified in the connected device list.

19. The apparatus of claim 15, wherein the request is received by and transmitted from the master device through a BLUETOOTH® stack.

20. The apparatus of claim 15, wherein the first wireless device attempts to connect to the second wireless device in response to receiving the request from the master device.

21. The apparatus of claim 15, wherein the second wireless device is another master device of a piconet other than the at least one piconet.

22. A method of relaying connection requests between wireless devices in a wireless network including at least one piconet having a master device and one or more slave devices, the method comprising:
receiving, in the master device, a request from a first wireless device to connect to a second wireless device; and
relaying the request to the second wireless device in response to the second wireless device being one of the one or more slave devices;
wherein the first wireless device is outside the at least one piconet having the master device.

23. The method of claim 22, further comprising attempting to connect, by the second wireless device, to the first wireless device in response to receiving the request.

24. A method of relaying connection requests between wireless devices in a wireless network, the method comprising:
sending a connection request from a service client device to a service provision device by relaying the connection request from the service client device through a master device of the service provision device;
wherein the service provision device is supporting an ad hoc wireless network based on BLUETOOTH® and is set to a slave status.
